(19) United States
(12) Patent Application Publication
(10) Pub. No.: US 2015/0084732 A1
(43) Pub. Date: Mar. 26, 2015

(54) METHOD, MOLD AND SYSTEM FOR MANUFACTURING A TRANSFORMER COIL

(71) Applicants: Jong-Yun Lim, Chungchongnam-do (KR); Seung-Chul Lee, Chungchongnam-do (KR); Gun-Woo Nam, Chungchongnam-do (KR); Chang-Hyeon Lee, Chungchongnam-do (KR); Stephane Schaal, Sierentz (FR); Martin Carlen, Niederrohrdorf (CH); Samuel Outten, Wytheville, VA (US)

(72) Inventors: Jong-Yun Lim, Chungchongnam-do (KR); Seung-Chul Lee, Chungchongnam-do (KR); Gun-Woo Nam, Chungchongnam-do (KR); Chang-Hyeon Lee, Chungchongnam-do (KR); Stephane Schaal, Sierentz (FR); Martin Carlen, Niederrohrdorf (CH); Samuel Outten, Wytheville, VA (US)

(73) Assignee: ABB TECHNOLOGY LTD.

(21) Appl. No.: 14/397,702

(22) PCT Filed: May 3, 2012
(86) PCT No.: PCT/US12/36207

§ 371 Date: Oct. 29, 2014

(51) Int. Cl. H01F 27/24; H01F 27/34; H01F 27/28; H01F 27/33; H01F 41/00; H01F 41/06

(52) U.S. Cl. CPC H01F 27/24; H01F 41/005; H01F 41/06; H01F 27/2895; H01F 27/33; H01F 27/346
USPC 336/213; 425/117; 264/272.19; 242/433.2; 29/602.1

(57) ABSTRACT

There is disclosed a transformer, comprising a triangular wound core; a low voltage LV winding; and at least one high voltage HV foil disc winding and a method for manufacturing a transformer coil, comprising providing a high voltage HV inner mold assembly; and winding at least one HV foil disc winding on the HV inner mold assembly. There is also disclosed a mold for manufacturing a transformer coil, comprising side gears respectively arranged at top and bottom positions of a triangular wound core; a high voltage HV inner mold assembly connected to the side gears; and a HV outer mold assembly connected to the side gears, wherein the HV outer mold assembly has a top opening across a length thereof.

### FIELD OF THE INVENTION

The present invention relates generally to the field of transformer technology, and in particular, relates to a transformer and a method, a mold for manufacturing the transformer coil.

### BACKGROUND OF THE INVENTION

Triangular wound core transformers have many benefits such as lower losses, reduced noise level, lower weight, smaller inrush current, smaller foot print, more manageable external magnetic radiation field and lower third harmonics in a three phase distribution system.

A triangular wound core for three phase distribution transformers typically consists of three core frames, which are essentially a group of one or more loops of magnetic steel or a similar, low magnetic reluctance material. The core frames are fitted together such that when viewed from above, the core takes the form of a triangle. FIG. 1 shows a transformer 100 comprising a triangular wound core 101, a low voltage (LV) coil 102 and a high voltage (HV) coil 103. Each phase of the transformer fits on a single core leg, through which two of the loops pass, as shown in FIG. 1. Each core leg is composed of part of two core frames which fit together to form the vertical core leg. Closed core loops contribute to the unique properties of the triangular wound core transformers, but the loops cannot be opened to allow insertion of coils. As such, the high and low voltage coils of each phase must be wound on the assembled core. This is distinct from typical construction of dry type transformers with stacked cores, which allow the coils to be assembled separately from the core, and placed afterwards.

The current technology for closed loop triangular cores consists of using rectangular (or circular) wire winding for the high voltage coils (see FIG. 2) and foil or wire winding for low voltage coils.

The wire winding has some disadvantages compared with foil disc winding (see FIG. 3) for the high voltage winding, such as higher material costs, higher labor times, higher partial-discharge problems in higher voltage class (for example in 24 kV and 36 kV class) etc.

Foil disc winding is widely used with many manufacturing & design advantages. However, due to a lack of winding machines and unclear winding processes, it has not been demonstrated for a closed loop triangular wound core.

Further, since all magnetic loop of a triangular wound core is closed and is not able to be opened mechanically to insert finished the high voltage (HV) and the low voltage (LV) coils to each core legs, all three phase HV and LV coils are wound on a triangular core leg directly, as shown in FIG. 1.

As conventional mold structure, LV mold for prepreg foil winding and HV mold for Vacuum Cast Coil (VCC) wire winding or foil disc winding are connected together to side gears during winding and casting process due to closed core loop geometry. And LV coil needs enough space at the end of mold for lead-out in such a combined mold structure during winding. Therefore, vertical casting process for a HV cast coil is typically used for a triangular wound core transformer.

Conductor slip can occur during the vertical casting process, especially in HV coils. Conductor slip can be a direct cause for dielectric failure during routine factory testing and/or on-site operation.

Vertical casting and the molds used therein can also alter the shape of the coil, which may lead to different mechanical strengths, especially during low ambient temperature operation. Due to the difference in coil designs from horizontal molding, additional thermal shock testing is required for vertically cast units. Experience with horizontal molding cannot be directly applied for certifications with vertical molding.

### SUMMARY OF THE INVENTION

One of the objectives of the embodiments of the present invention is to provide a method, a mold and a system for manufacturing a transformer coil, which obviates or at least mitigates at least part of the above problems in the prior art.

In one aspect of the present invention, there is provided a transformer, comprising a triangular wound core; a low voltage LV winding; and at least one high voltage HV foil disc winding.

In one of the embodiments of the present invention, the at least one HV foil disc winding is cast horizontally to form a HV coil.

In one aspect of the present invention, there is provided a method for manufacturing a transformer coil, comprising: providing a high voltage HV inner mold assembly; and winding at least one HV foil disc winding on the HV inner mold assembly.

In one of the embodiments of the present invention, a triangular wound core is provided on a rail of a winding part of a winding machine, and the rail is moved such that the triangular wound core is repositioned to a next foil disc winding position, after a foil disc winding is wound.

In one of the embodiments of the present invention, the step of providing a HV inner mold assembly comprises connecting the HV inner mold assembly to side gears respectively arranged at the top and bottom position of the triangular wound core.

In one of the embodiments of the present invention, the method further comprises the step of: connecting a HV outer mold assembly to the side gears, wherein said the HV outer mold assembly has a top opening across the length of the HV outer mold assembly; and performing horizontal casting of the HV foil disc winding through the top opening.

In one of the embodiments of the present invention, the walls are respectively formed on both edge of the top opening across the length of the HV outer mold assembly, and a dome plate is installed on each of the side gears, thereby forming a dome area on the top opening of the HV outer mold assembly.

In one of the embodiments of the present invention, the walls are respectively formed on both edge of the top opening across the length of the HV outer mold assembly, and one or more side plate assembly is fitted around the triangular wound core and at the top and/or bottom position of the triangular wound core to cover the space between the HV inner mold assembly and the HV outer mold assembly, and a dome plate is installed on the respective side plate assembly, thereby forming a dome area on the top opening of the HV outer mold assembly.

In one of the embodiments of the present invention, the method further comprises the step of: connecting a low voltage LV inner mold assembly to the side gears; and winding a LV winding on the LV inner mold assembly.

In one of the embodiments of the present invention, the at least one HV foil disc winding comprises multiple HV foil disc windings, the method further comprising: winding the multiple HV foil disc windings at the same time on the HV inner mold assembly.

In one aspect of the present invention, there is provided a mold for manufacturing a transformer coil, comprising side gears respectively arranged at top and bottom positions of a triangular wound core; a high voltage HV inner mold assembly connected to the side gears; and a HV outer mold assembly connected to the side gears, wherein the HV outer mold assembly has a top opening across a length thereof.

In one of the embodiments of the present invention, the HV outer mold assembly is a shaped mold consisting of one or more metal forms.

In one of the embodiments of the present invention, walls are respectively formed on both edge of the top opening across the length of the HV outer mold assembly, and a dome plate is installed on each of the side gears, thereby forming a dome area on the top opening of the HV outer mold assembly.

In one of the embodiments of the present invention, walls are respectively formed on both edge of the top opening across the length of the HV outer mold assembly, one or more side plate assembly is fitted around the triangular wound core and at the top and/or bottom position of the triangular wound core to cover the space between the HV inner mold assembly and the HV outer mold assembly, and a dome plate installed on the respective side plate assembly, thereby forming a dome area on the top opening of the HV outer mold assembly.

In one of the embodiments of the present invention, the mold further comprises one or more connection plates fixed on the top opening of the HV outer mold assembly.

In one aspect of the present invention, there is provided a system for manufacturing a transformer coil, which comprises a winding machine having a winding part, a decoiler part and material feeding arms; a triangular wound core mounted on a rail at winding part of a winding machine; and a mold according to the embodiments of the present invention.

### BRIEF DESCRIPTION OF DRAWINGS

Having thus described the example embodiments of the invention in general terms, reference will now be made to the accompanying drawings, which are not necessarily drawn to scale, and wherein:

FIG. 1 is a schematic representation of a transformer with a triangular wound core, a LV coil and a HV coil;

FIG. 2 is a sectional view of a wire winding by conventional wire winding machine;

FIG. 3 is a sectional view of a foil disc winding by conventional foil disc winding machine;

FIGS. 4A-4C are top, front and side views of a mold for horizontal casting of a triangular wound core according to one embodiment of the present invention, respectively;

FIG. 5 is a perspective view of a mold for horizontal casting of a triangular wound core according to one embodiment of the present invention;

FIG. 6 schematically shows a plurality of embodiments of a mold for horizontal casting of a triangular wound core according to one embodiment of the present invention;

FIG. 7 shows a foil disc winding machine for a triangular wound core according to one embodiment of the present invention;

FIG. 8 is a flow chart illustrating the method for manufacturing a transformer coil according to one embodiment of the present invention; and

FIG. 9 is a flow chart illustrating in general the detailed steps in a method for manufacturing a transformer coil according to one embodiment of the present invention.

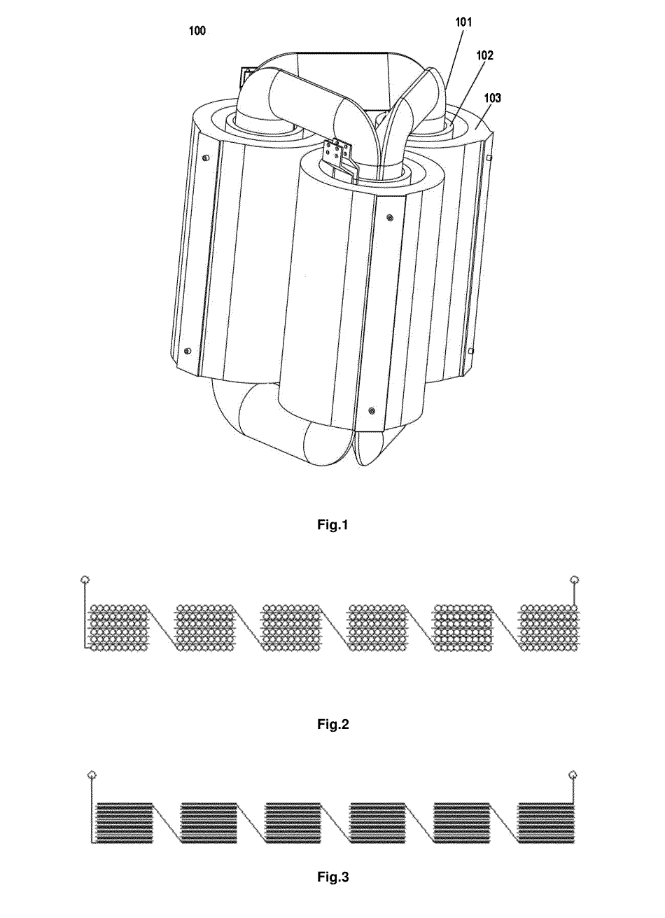

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

In some example embodiments, there is provided a transformer, which can comprise a triangular wound core; a low voltage LV winding; and at least one high voltage HV foil disc winding.

In some example embodiments, the at least one HV foil disc winding is cast horizontally to form a HV coil.

In some example embodiments, there is provided a mold for horizontal cast coil. The mold does not interfere with the LV lead out. Furthermore, the mold is designed such that an epoxy system can be poured into HV coils of triangular wound core at the horizontal position.

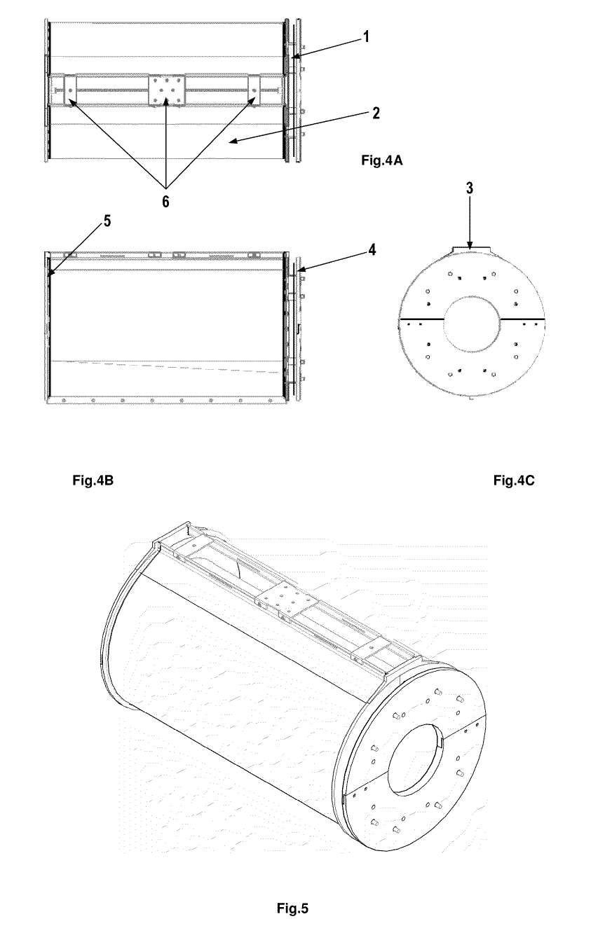

Specifically, as shown in FIGS. 4A-4C, 5 and 6, a mold for manufacturing a transformer coil according to one embodiment of the present invention can comprise two side gears 4, 5; a HV inner mold assembly; and a HV outer mold assembly 2. In one embodiment, the two side gears 4, 5 are respectively arranged at the top and bottom position of a triangular wound core to horizontally wind a LV and HV coil.

In the context of the specification, the top and bottom position of a triangular wound core refer to the positions of both ends of the LV and HV windings on a triangular wound core, respectively. The terms top and bottom opposition is widely used in vertical casting representing the upper and lower position respectively. The same terms are used here for horizontal casting to indicate the same position on a triangular wound core. As illustrated by FIGS. 4-6, one side gear 4 is at the top (right) position and the other gear 5 is at the bottom (left) position for vertical casting.

One embodiment, the HV inner mold assembly is connected to the side gears 4, 5 for the winding of HV foil disc windings and sealed with the side gears 4, 5 for horizontal casting. The HV outer mold assembly 2 is also connected to the side gears 4, 5 and sealed with the side gears 4, 5, according to one of the embodiments, for horizontal casting.

In one of the example embodiments, the HV outer mold assembly 2 is a shaped mold that consists of one or more metal forms that together fit to the desired shape of the sides of the coil. It is fitted to assemble the side gears 4, 5 and/or the side plate assembly 1, 1′ without any epoxy leakage during casting process. It is also fitted to avoid any mechanical interference with the other phase molds.

In one embodiment, the top opening of the HV outer mold assembly 2 is provided across the length of the HV outer mold assembly 2. Two walls are formed across the length and on both edge of the top opening of the HV outer mold assembly 2.

In one of the example embodiments, the walls are respectively formed on both edge of the top opening across the length of the HV outer mold assembly 2, and a dome plate 3 is installed on each of the side gears 4, 5, thereby forming a dome area on the top opening of the HV outer mold assembly 2.

In one of the example embodiments, the walls are respectively formed on both edge of the top opening across the length of the HV outer mold assembly 2, one or more side plate assembly 1, 1′ is fitted around the triangular wound core and at the top and/or bottom position of the triangular wound core to cover the space between the HV inner mold assembly and the HV outer mold assembly 2, and a dome plate 3 installed on the respective side plate assembly 1, 1′, thereby forming a dome area on the top opening of the HV outer mold assembly 2.

In one of the example embodiments, the mold further comprises a side plate assembly 1, 1′, which is consisted of two or more parts and fitted around the triangular wound core at the top and/or bottom position of the triangular wound core to cover the space between the HV inner mold assembly and the HV outer mold assembly 2. In case that one or more side plate assembly 1, 1′ is installed, the dome plates 3 will have to be installed on respective side plate assembly 1, 1′ to form a dome area on a top opening of the HV outer mold assembly 2.

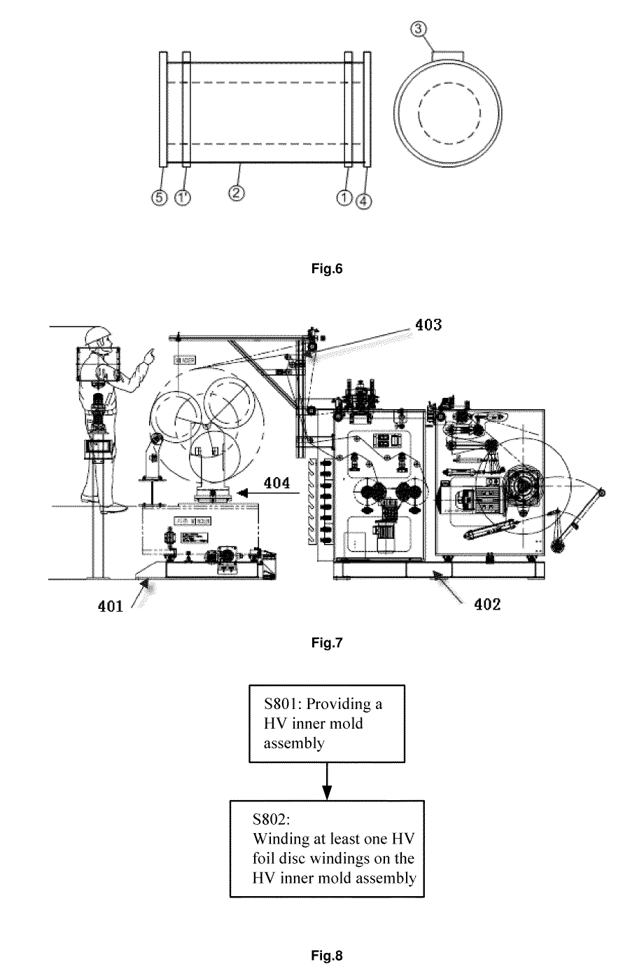

According to different embodiments, different combinations of the side gears 4, 5 and the side plate assembly 1, 1′ can be used, as described below and in FIG. 6:

Case 1: no side plate assembly 1, 1′ installed, the dome plates 3 installed on both side gears 4, 5.

Case 2: one side plate assembly 1 installed at the top position, the dome plates 3 installed on side gears 5 and side plate assembly 1, respectively.

Case 3: one side plate assembly 1′ installed at the bottom position, the dome plates 3 installed on side gears 4 and side plate assembly 1′, respectively.

Case 4: two side plate assembly 1, 1′ installed, the dome plates 3 installed on both side plate assembly 1, 1′.

In one of the example embodiments, the mold further comprises one or more connection plates 6 fixed on the top opening of the HV outer mold assembly 2 to lead out to a customer cable connection and tap changing. To lead out those connections at HV cast coil, some space (the dome area) is generally needed in cast coil transformer.

In one of the example embodiments, the triangular wound core may be in any other shape with closed loop. The triangular wound core may have a circular or polygonal cross section.

Referring now to FIG. 7, in one of the example embodiments, a system for manufacturing a transformer coil comprises a winding machine having a winding part 401, a decoiler part 402 and material feeding arms 403; a triangular wound core mounted on a rail 404 at winding part 401 of a winding machine; and a mold as described above.

Conventional wire winding machine for triangular wound core has a wire winding part and a wire decoiler part. The wire winding part is operated by motor controlled gear to rotate mold and winding directly on a leg of triangular core. It is fixed part of machine. And it does not have conductor alignment function and tension control function for other winding technologies, including foil disc winding. The wire decoiler part has a tension control for a wire. It is fixed part of machine. Since it does not have a conductor alignment function, wire alignment is provided manually during winding. Without an alignment function, foil disk winding is complex and manually intensive.

A conventional foil disc winding machine has a foil winding part and a decoiler part for conductor and insulation material. The foil winding part can be moved into position to wind each disc and it is fully controlled with the decoiler part for the tension control and alignment of both foil conductor and insulation material.

To achieve foil disc winding on a triangular wound core, a new winding process is introduced into the conventional wire winding process for triangular wound cores.

Referring now to FIG. 8, a method for manufacturing a transformer coil comprises the following steps. In step 801, a HV inner mold assembly is provided. In step 802, at least one HV foil disc windings is wound on the HV inner mold assembly.

According to one of the example embodiments, a triangular wound core is provided on a rail 404 of a winding part 401 of a winding machine, and the rail 404 is moved such that the triangular wound core is repositioned to a next foil disc winding position, after a foil disc winding is wound.

According to one of the example embodiments, the HV inner mold assembly is connected to side gears 4, 5 respectively arranged at the top and bottom position of the triangular wound core.

In one of the example embodiments, the method further comprises the step of connecting a LV inner mold assembly to the two side gears 4, 5 at the top and bottom position of the triangular wound core; and winding LV foil disc windings on the LV inner mold assembly.

In one of the example embodiments, the method further comprises the step of connecting a HV outer mold assembly 2 to the side gears 4, 5, wherein said the HV outer mold assembly 2 has a top opening across the length of the HV outer mold assembly 2; and performing horizontal casting of the HV foil disc winding through the top opening.

In one of the example embodiments, the walls are respectively formed on both edge of the top opening across the length of the HV outer mold assembly 2, and a dome plate 3 is installed on each of the side gears 4, 5, thereby forming a dome area on the top opening of the HV outer mold assembly 2.

In one of the example embodiments, the walls are respectively formed on both edge of the top opening across the length of the HV outer mold assembly 2, one or more side plate assembly 1, 1′ is fitted around the triangular wound core and at the top and/or bottom position of the triangular wound core to cover the space between the HV inner mold assembly and the HV outer mold assembly 2, and a dome plate 3 is installed on the respective side plate assembly 1, 1′, thereby forming a dome area on the top opening of the HV outer mold assembly 2.

In one of the example embodiments, the method further comprises the step of fixing one or more connection plates 6 on the top opening of the HV outer mold assembly 2.

In one of the example embodiments, the method further comprises the step of winding multiple HV foil disc windings at the same time on the HV inner mold assembly 2; or winding HV foil disc windings at the same time on one or more phases.

In one of the example embodiments, the winding part 401 including working table & triangular wound core can be potential relocated and separately moved to any direction (up & down, back & forward, left & light) based on different core size, different winding position, multi disc winding at the same time on a phase and multi disc winding at the same time on 2-3 phases (multi-phase winding).

Note that the winding apparatus with a triangular wound core is put on a rail at bottom with position sensor, motor & motor control. It is communicated with the other part of machine to move a correct winding position. Laser pointer may also be used for a worker to check a correct disc positioning during winding. And also a working table for workers may be introduced for operational health and safety.

In one of the example embodiments, a tension control devices for foil conductors and insulation materials are applied. And a deburring and a welding device for disc connection and tap lead out are also introduced to improve quality and productivity. It is communicated with the other part of machine to keep a winding speed and a correct tension. The process may use decoilers for one or more conductors and one or more layers of insulation, adjusted to the same or different parameters.

In one of the example embodiments, the material feeding arm 403 supplies one or more conductors and one or more insulation material to the winding apparatus. It can be adjusted & potential changed to feed from any direction (over the core, under the core, through the core) based on different core size, different winding position, multi disc winding at the same time on a phase and multi-phase winding. In addition, a plurality of feeding arms may be used for multi disc or multi-phase winding.

In one of the example embodiments, an alternative step in the process may provide disc positioning by movement of the tension decoiler part or parts (separate or together) with or without disc positioning movement by the winding part.

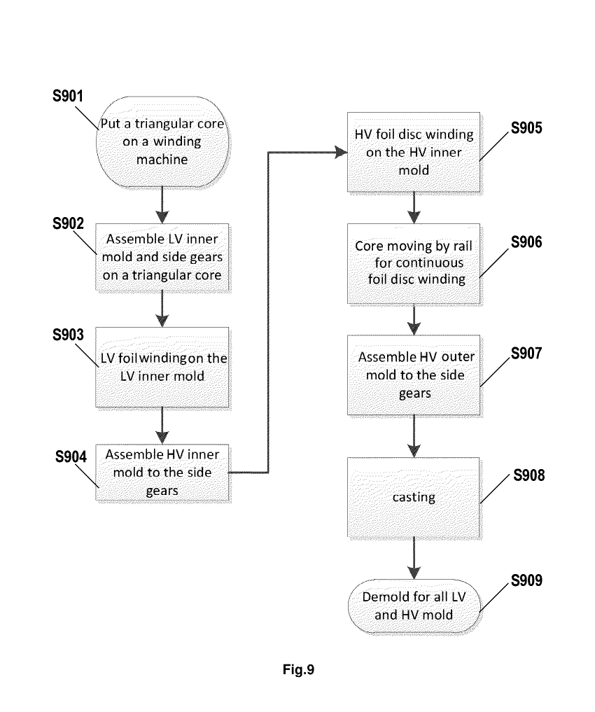

The method for manufacturing a transformer coil according to one embodiment of the present invention will be further described in general with detailed steps as shown in FIG. 9.

as shown in FIG. 9, at the step 901, a triangular wound core is put on a winding machine.

At the step 902, a LV inner mold assembly is assembled together with side gears on the triangular wound core.

At the step 903, a LV foil winding is wound on the LV inner mold assembly.

At the step 904, a HV inner mold assembly is assembled to the side gears.

At the step 905, a HV foil disc winding is wound on the HV inner mold assembly.

At the step 906, after a HV foil disc winding is wound, a rail mounted on the winding part of the winding machine is moved such that the triangular wound core provided on the rail is repositioned to a next foil disc winding position. The above process for a HV foil disc winding is repeated until all the HV foil discs are wound.

After the winding process, at the step 907, a HV outer mold assembly is assembled to the side gears.

At the step 908. the HV foil disc winding is cast to form a HV coil. According to embodiment of the present invention, the HV foil disc winding may be cast horizontally or vertically to form a HV coil.

After the casting process, at the step 909, the method is finished by demolding all LV and HV molds from the triangular wound core.

According to one alternative embodiment, the process for the LV foil winding and the HV foil disc winding may be performed using different winding machines. In this case, after the LV foil winding is finished, the finished LV foil winding and the triangular wound core will be moved to a different HV foil disc winding machine. Then, the HV inner mold assembly is assembled to the side gears. A HV foil disc winding is wound on the HV inner mold assembly by the different HV foil disc winding machine.

In one of the example embodiments, the HV foil disc winding step may further comprise the step of winding multiple HV foil disc windings at the same time on the HV inner mold assembly; or winding HV foil disc windings at the same time on one or more phases of the triangular wound core. The machine can wind multiple conductors and multiple strips of insulation as well as multiple disks at once.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A transformer, comprising:
a triangular wound core;
a low voltage LV winding; and
at least one high voltage HV foil disc winding.

2. The transformer of claim 1, wherein the at least one HV foil disc winding is cast horizontally to form a HV coil.

3. A method for manufacturing a transformer coil, comprising:
providing a high voltage HV inner mold assembly; and
winding at least one HV foil disc winding on the HV inner mold assembly.

4. The method of claim 3, wherein a triangular wound core is provided on a rail of a winding part of a winding machine, and the rail is moved such that the triangular wound core is repositioned to a next foil disc winding position, after a foil disc winding is wound.

5. The method of claim 3, wherein the step of providing the HV inner mold assembly comprises connecting the HV inner mold assembly to side gears respectively arranged at the top and bottom position of the triangular wound core.

6. The method of claim 3, further comprising:
connecting a HV outer mold assembly to the side gears, wherein the HV outer mold assembly has a top opening across a length of the HV outer mold assembly; and
performing horizontal casting of the HV foil disc winding through the top opening.

7. The method of claim 6, wherein walls are respectively formed on both edges of the top opening across the length of the HV outer mold assembly, and a dome plate is installed on each of the side gears, thereby forming a dome area on the top opening of the HV outer mold assembly.

8. The method of claim 6, wherein, walls are respectively formed on both edges of the top opening across the length of the HV outer mold assembly, one or more side plate assemblies is fitted around the triangular wound core and at least one of the top or bottom position of the triangular wound core to cover a space between the HV inner mold assembly and the HV outer mold assembly, and a dome plate is installed on the respective side plate assembly, thereby forming a dome area on the top opening of the HV outer mold assembly.

9. The method of claim 3, further comprising:
connecting a low voltage LV inner mold assembly to the side gears; and
winding a LV winding on the LV inner mold assembly.

10. The method of claim 3, wherein said at least one HV foil disc winding comprises multiple HV foil disc windings, and the method further comprising: winding the multiple HV foil disc windings at a same time on the HV inner mold assembly.

11. A mold for manufacturing a transformer coil, comprising:
side gears respectively arranged at top and bottom positions of a triangular wound core;
a high voltage HV inner mold assembly connected to the side gears; and
a HV outer mold assembly connected to the side gears, wherein the HV outer mold assembly has a top opening across a length thereof.

12. The mold of claim 11, wherein the HV outer mold assembly is a shaped mold consisting of one or more metal forms.

13. The mold of claim 11, wherein walls are respectively formed on both edges of the top opening across a length of the HV outer mold assembly, and a dome plate is installed on each of the side gears, thereby forming a dome area on the top opening of the HV outer mold assembly.

14. The mold of claim 11, wherein walls are respectively formed on both edges of the top opening across a length of the HV outer mold assembly, one or more side plate assemblies is fitted around the triangular wound core and at least one of the top and/or bottom position of the triangular wound core to cover a space between the HV inner mold assembly and the HV outer mold assembly, and a dome plate installed on the respective side plate assembly, thereby forming a dome area on the top opening of the HV outer mold assembly.

15. The mold of claim 11, further comprising:
one or more connection plates fixed on the top opening of the HV outer mold assembly.

16. The mold of claim 12, further comprising:
one or more connection plates fixed on the top opening of the HV outer mold assembly.

17. The mold of claim 13, further comprising:
one or more connection plates fixed on the top opening of the HV outer mold assembly.

18. The mold of claim 14, further comprising:
one or more connection plates fixed on the top opening of the HV outer mold assembly.

19. The method of claim 4, further comprising:
connecting an HV outer mold assembly to the side gears, wherein the HV outer mold assembly has a top opening across a length of the HV outer mold assembly; and
performing horizontal casting of the HV foil disc winding through the top opening.

20. The method of claim 5, further comprising:
connecting an HV outer mold assembly to the side gears, wherein the HV outer mold assembly has a top opening across a length of the HV outer mold assembly; and
performing horizontal casting of the HV foil disc winding through the top opening.
